(19) United States
(12) Patent Application Publication
(10) Pub. No.: US 2026/0178328 A1
(43) Pub. Date: Jun. 25, 2026

(54) INSTRUCTION GENERATION APPARATUS AND METHOD, DEVICE, STORAGE MEDIUM, AND COMPUTER PROGRAM PRODUCT

(71) Applicant: Guangzhou Pwr Sply Bur of Gngdng Pwr Grd Co., Ltd., Guangzhou (CN)

(72) Inventors: Yong WANG, Guangzhou (CN); Lingming KONG, Guangzhou (CN); Yilong CHEN, Guangzhou (CN); Jun CHEN, Guangzhou (CN); Mianzhi CHEN, Guangzhou (CN)

(73) Assignee: Guangzhou Pwr Sply Bur of Gngdng Pwr Grd Co., Ltd., Guangzhou (CN)

(21) Appl. No.: 18/832,283

(22) PCT Filed: Oct. 31, 2023
(86) PCT No.: PCT/CN2023/128188

§ 371 Date: Jul. 23, 2024

(30) Foreign Application Priority Data
Jul. 28, 2023 (CN) 202310949140.2

(51) Int. Cl. G06F 9/30; G06F 9/38

(52) U.S. Cl. CPC G06F 9/30038; G06F 9/3836

(57) ABSTRACT

An instruction generation apparatus includes: a retrieval instruction transmitting module configured to acquire a retrieval decoding signal corresponding to a target neural network, and generate a retrieval instruction according to the retrieval decoding signal, wherein the retrieval instruction is configured to control a neural network processor to acquire an input characteristic diagram and a convolution kernel; a matrix instruction transmitting module configured to acquire a matrix decoding signal, and generate a matrix computation instruction according to the matrix decoding signal, wherein the matrix computation instruction is configured to control the neural network processor to perform an operation of a convolution computation on the input characteristic diagram and the convolution kernel; a storage instruction transmitting module configured to acquire a storage decoding signal, and generate a storage instruction according to the storage decoding signal, wherein the storage instruction is being configured to control the neural network processor to store an output characteristic diagram.

### CROSS REFERENCE TO RELATED APPLICATIONS

The present application is a US national stage application of PCT international application PCT/CN2023/128188, filed on Oct. 31, 2023, which claims priority to Chinese Patent Application No. 202310949140.2, entitled “Instruction Generation Apparatus and Method, Device, Storage Medium, and Computer Program Product”, filed on Jul. 28, 2023, the contents of which are expressly incorporated herein by reference in their entirety.

### TECHNICAL FIELD

The present disclosure relates to the field of control technology, and particularly to an instruction generation apparatus and method, a device, a storage medium, and a computer program product.

### BACKGROUND

As problems that can be solved by neural networks become more and more complicated, a scale of the neural networks gradually increases, and neural network processors used for processing neural network operations have a very large amount of computation.

In the conventional technology, the neural network processor successively performs a group of operations including data retrieval, calculation, and storage under control instructions issued by a corresponding instruction generation apparatus. The instruction generation apparatus in the conventional technology transmits control instructions to the neural network processor one by one according to an instruction sequence, to control the processor to process the neural network operations.

However, the above-mentioned instruction generation apparatus may cause lower execution efficiency of the neural network operations.

### SUMMARY

In view of this, it is necessary to provide an instruction generation apparatus and method, a device, a storage medium and a computer program product capable of improving the operation efficiency of the neural network.

In the first aspect of the present disclosure, an instruction generation apparatus is provided, including: a retrieval instruction transmitting module, a matrix instruction transmitting module, and a storage instruction transmitting module;
the retrieval instruction transmitting module is configured to acquire a retrieval decoding signal corresponding to a target neural network, and generate a retrieval instruction according to the retrieval decoding signal, wherein the retrieval instruction is configured to control a neural network processor to acquire, according to the retrieval instruction, an input characteristic diagram and a convolution kernel;
the matrix instruction transmitting module is configured to acquire a matrix decoding signal corresponding to the target neural network, and generate a matrix computation instruction according to the matrix decoding signal, wherein the matrix computation instruction is configured to control the neural network processor to perform, according to the matrix computation instruction, an operation of a convolution computation on the input characteristic diagram and the convolution kernel;
the storage instruction transmitting module is configured to acquire a storage decoding signal corresponding to the target neural network, and generate a storage instruction according to the storage decoding signal, wherein the storage instruction is configured to control the neural network processor to store an output characteristic diagram corresponding to the target neural network to a target address.

In an embodiment, the retrieval decoding signal includes a first hardware loop signal and a first address generation signal, the retrieval instruction transmitting module includes a first hardware loop control unit and a first address generation unit;
the first hardware loop control unit is configured to acquire the first hardware loop signal, perform a first hardware loop process according to the first hardware loop signal, and obtain a first sequence group and a first mask sequence;
the first address generation unit is configured to acquire the first address generation signal, the first sequence group and the first mask sequence, perform a first address generation process according to the first address generation signal, the first sequence group and the first mask sequence, and obtain the retrieval instruction.

In an embodiment, the first hardware loop signal includes a first accumulation signal, a second accumulation signal, a third accumulation signal, and a fourth accumulation signal; the first hardware loop control unit includes a first accumulator, a second accumulator, a third accumulator, a fourth accumulator, a first finite state machine, and a first mask generator;
the first accumulator is configured to acquire the first accumulation signal, perform first accumulation operations according to the first accumulation signal, and output a first accumulation result corresponding to each first accumulation operation to the first finite state machine and the first mask generator;
the second accumulator is configured to acquire the second accumulation signal and first accumulation results, perform second accumulation operations according to the second accumulation signal and the first accumulation results, and output a second accumulation result corresponding to each second accumulation operation to the first finite state machine;
the third accumulator is configured to acquire the third accumulation signal and second accumulation results, perform third accumulation operations according to the third accumulation signal and the second accumulation results, and output a third accumulation result corresponding to each third accumulation operation to the first finite state machine;
the fourth accumulator is configured to acquire the fourth accumulation signal and third accumulation results, perform fourth accumulation operations according to the fourth accumulation signal and the third accumulation results, and output a fourth accumulation result corresponding to each fourth accumulation operation to the first finite state machine;
the first finite state machine is configured to obtain the first sequence group according to the first accumulation results, the second accumulation results, the third accumulation results, and the fourth accumulation results;
the first mask generator is configured to obtain the first mask sequence according to the first accumulation results.

In an embodiment, the first address generation signal includes an input characteristic diagram address, a convolution kernel address, a first address step size, an up-sampling enable signal, and a fill signal; the first address generation unit includes a first address generation register and a second address generation register;
the first address generation register is configured to acquire the input characteristic diagram address and the convolution kernel address, and generate a first base address according to the input characteristic diagram address and the convolution kernel address;
the second address generation register is configured to acquire the first address step size, the up-sampling enable signal, the fill signal, the first base address, the first sequence group and the first mask sequence, and obtain the retrieval instruction according to the first address step size, the up-sampling enable signal, the fill signal, the first base address, the first sequence group and the first mask sequence.

In an embodiment, the matrix decoding signal includes a second hardware loop signal, a second address generation signal, and a matrix configuration signal; the matrix instruction transmitting module includes a second hardware loop control unit, a second address generation unit, and a matrix configuration unit;
the matrix configuration unit is configured to acquire the matrix configuration signal, and generate a matrix configuration result according to the matrix configuration signal;
the second hardware loop control unit is configured to acquire a second hardware loop signal, perform a second hardware loop process according to the second hardware loop signal, and obtain a second sequence group and a second mask sequence;
the second address generation unit is configured to acquire the matrix configuration result, the second sequence group, the second mask sequence and the second address generation signal, perform a second address generation process according to the matrix configuration result, the second sequence group, the second mask sequence and the second address generation signal, and obtain the matrix computation instruction.

In an embodiment, the storage decoding signal includes a third hardware loop signal and a third address generation signal; the storage instruction transmitting module includes a third hardware loop control unit and a third address generation unit;
the third hardware loop control unit is configured to acquire the third hardware loop signal, perform a third hardware loop process according to the third hardware loop signal, and obtain a third sequence group and a third mask sequence;
the third address generation unit is configured to acquire the third sequence group and the third address generation signal, perform a third address generation process according to the third address generation signal, the third sequence group and the third mask sequence, and obtain the storage instruction.

In the second aspect of the present disclosure, an instruction generation method is provided, including:
acquiring a retrieval decoding signal, and generating a retrieval instruction according to the retrieval decoding signal, wherein the retrieval instruction is configured to control a neural network processor to acquire, according to the retrieval instruction, an input characteristic diagram and a convolution kernel;
acquiring a matrix decoding signal, and generating a matrix computation instruction according to the matrix decoding signal, wherein the matrix computation instruction is configured to control the neural network processor to perform, according to the matrix computation instruction, an operation of a convolution computation on the input characteristic diagram and the convolution kernel; and
acquiring a storage decoding signal, and generating a storage instruction according to the storage decoding signal, wherein the storage instruction is configured to control the neural network processor to store an output characteristic diagram corresponding to a target neural network to a target address.

In an embodiment, the retrieval decoding signal includes a first hardware loop signal and a first address generation signal, and the method further includes:
performing a first hardware loop process according to the first hardware loop signal, and obtaining a first sequence group and a first mask sequence;
performing a first address generation process according to the first address generation signal, the first sequence group, and the first mask sequence, and obtaining the retrieval instruction.

In an embodiment, the first hardware loop signal includes a first accumulation signal, a second accumulation signal, a third accumulation signal, and a fourth accumulation signal; and the method further includes:
performing a first accumulation operation according to the first accumulation signal, outputting a first accumulation result corresponding to each first accumulation operation;
performing a second accumulation operation according to the second accumulation signal and the first accumulation result, outputting a second accumulation result corresponding to each second accumulation operation;
performing a third accumulation operation according to the third accumulation signal and the second accumulation result, outputting a third accumulation result corresponding to each third accumulation operation;
performing a fourth accumulation operation according to the fourth accumulation signal and the third accumulation result, outputting a fourth accumulation result corresponding to each fourth accumulation operation;
obtaining the first sequence group according to each first accumulation result, each second accumulation result, each third accumulation result, and each fourth accumulation result; and
obtaining the first mask sequence according to each first accumulation result.

In an embodiment, the first address generation signal includes an input characteristic diagram address, a convolution kernel address, a first address step size, an up-sampling enable signal, and a fill signal; and the method further includes:
generating a first base address according to the input characteristic diagram address and the convolution kernel address; and
obtaining the retrieval instruction according to the first address step size, the up-sampling enable signal, the fill signal, the first base address, the first sequence group, and the first mask sequence.

In an embodiment, the matrix decoding signal includes a second hardware loop signal, a second address generation signal, and a matrix configuration signal; and the mehod further includes:
generating a matrix configuration result according to the matrix configuration signal;
performing a second hardware loop process according to the second hardware loop signal, and obtaining a second sequence group and a second mask sequence;
performing a second address generation process according to the matrix configuration result, the second sequence group, the second mask sequence, and the second address generation signal, and obtaining the matrix computation instruction.

In an embodiment, the storage decoding signal includes a third hardware loop signal and a third address generation signal; and the method further includes:
performing a third hardware loop process according to the third hardware loop signal, obtaining a third sequence group and a third mask sequence;
performing a third address generation process according to the third address generation signal, the third sequence group, and the third mask sequence, and obtaining the storage instruction.

In the third aspect of the present disclosure, a computer device is provided, including the instruction generation apparatus provided in the above first aspect.

In the fourth aspect of the present disclosure, a computer-readable storage medium is provided, on which a computer program is stored, the computer program, when executed by a processor, causes the processor to implement the method provided in the above second aspect.

In the fifth aspect of the present disclosure, a computer program product is provided, including a computer program, the computer program, when executed by a processor, causes the processor to implement the method provided in the above second aspect.

With the instruction generation apparatus and method, the device, the storage medium and the computer program product, the retrieval decoding signal corresponding to the target neural network is acquired, and a retrieval instruction is generated according to the retrieval decoding signal, the retrieval instruction is configured to control the neural network processor to acquire, according to the retrieval instruction, the input characteristic diagram and the convolution kernel; the matrix decoding signal is acquired, and the matrix computation instruction is generated according to the matrix decoding signal, the matrix computation instruction is configured to control the neural network processor to perform, according to the matrix computation instruction, the operation of convolution computation on the input characteristic diagram and the convolution kernel; the storage decoding signal is acquired, and the storage instruction is generated according to the storage decoding signal, the storage instruction is configured to control the neural network processor to store the output characteristic diagram corresponding to the target neural network to the target address. In such a manner, the retrieval instruction transmitting module, the matrix instruction transmitting module, the vector instruction transmitting module and the storage instruction transmitting module in the present disclosure control the neural network processor to perform retrieval, computation and storage operations respectively, accordingly the neural network processor can be controlled to simultaneously perform multiple groups of operations including the retrieval, computation and storage, thereby avoiding the problem of lower efficiency caused by the control apparatus transmitting the control instructions one by one to the neural network processor to control the processor to perform the operations group by group in the conventional technology, and accordingly effectively improving the efficiency of controlling the neural network processor to process the neural network operations.

### BRIEF DESCRIPTION OF THE DRAWINGS

In order to illustrate more clearly the technical solution in embodiments of the present disclosure, accompanying drawings required in the description of the embodiments will be briefly described below. Obviously, the drawings in the following description are merely exemplary, and other drawings may be obtained by those skilled in the art according to the provided drawings without creative efforts.

FIG. 1 shows an application environment diagram of an instruction generation apparatus according to an embodiment.

FIG. 2 shows a module structure of the instruction generation apparatus in FIG. 1.

FIG. 3 shows a module structure of a retrieval instruction transmitting module in FIG. 2.

FIG. 4 shows a unit structure of a first hardware loop control unit in FIG. 3.

FIG. 5 shows a unit structure of a first address generation unit in FIG. 3.

FIG. 6 shows a module structure of a matrix instruction transmitting module in FIG. 2.

FIG. 7 shows a module structure of a storage instruction transmitting module in FIG. 2.

### REFERENCE SIGNS

100, retrieval instruction transmitting module; 102, first hardware loop control unit; 1022, first accumulator; 1024, second accumulator; 1026, third accumulator; 1028, fourth accumulator; 1032, first finite state machine; 1034, first mask generator; 104, first address generation unit; 1042, first address generation register; 1044, second address generation register; 200, matrix instruction transmitting module; 202, matrix configuration unit; 204, second hardware loop control unit; 206, second address generation unit; 300, storage instruction transmitting module; 302, third hardware loop control unit; 304, third address generation unit.

### DETAILED DESCRIPTION

In order to facilitate the understanding of the present disclosure, the present disclosure will be described more comprehensively with reference to related accompanying drawings. Embodiments of the present disclosure are provided in the accompanying drawings. However, the present disclosure may be implemented in many different forms, and is not limited to the embodiments described in the specification. Rather, the purpose of providing these embodiments is to make the present disclosure more thorough and comprehensive.

Unless otherwise defined, all technical and scientific terms used in the specification have the same meaning as those commonly understood by those skilled in the art that belong to the present disclosure. The terms used in the specification of the present disclosure are merely intended to describe specific embodiments, and are not intended to limit the present disclosure.

It should be appreciated that the terms “first”, “second” and the like used in the present disclosure may be used for describing various elements in the specification, but the elements are not limited by these terms. These terms are only used for distinguishing the first element from the other. For example, without departing from the scope of the present disclosure, a first resistor may be referred to as a second resistor, and similarly, the second resistor may be referred to as the first resistor. Both the first resistor and the second resistor are resistors, but not the same resistor.

It should be appreciated that the “connection” in the following embodiments should be understood as “electrical connection”, “communication connection”, and the like if an electrical signal or data transfer exists among the connected circuits, modules, units, and the like.

In use herein, the singular forms “a”, “one” and “the/said” may also include plural forms unless the context clearly indicates another manner. It should also be understood that the term “include/comprise” or “have”, etc., refers to the presence of the stated features, entirety, steps, operations, components, portions or combinations thereof, but does not exclude the possibility of existing or adding one or more other features, entirety, steps, operations, components, portions or combinations thereof.

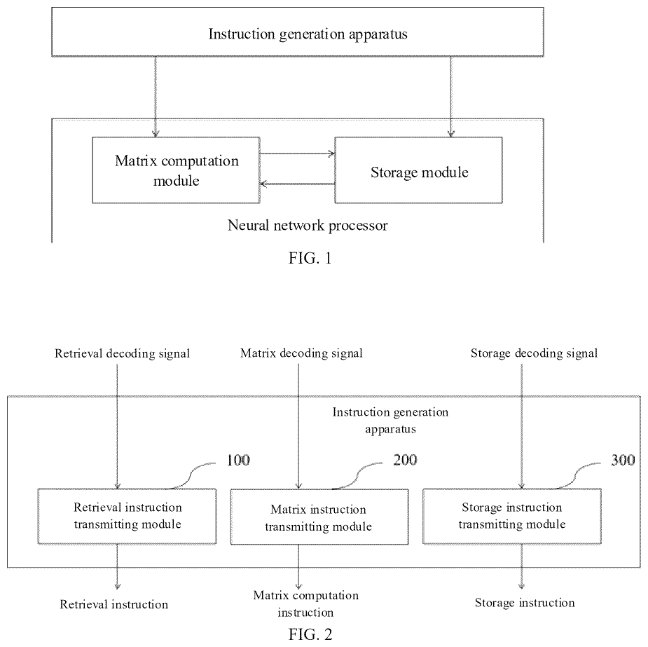

The instruction generation apparatus provided in the embodiment of the present disclosure may be applied to the application environment shown in FIG. 1. The instruction generated by the instruction generation apparatus is transmitted to a storage module of a neural network processor, and is configured to control the storage module to extract an input characteristic diagram and a convolution kernel required for a matrix computation, and transmit the input characteristic diagram and the convolution kernel to a matrix computation module of the neural network processor. The instruction generated by the instruction generation apparatus is further transmitted to the matrix computation module of the neural network processor, and is configured to control the matrix computation module to perform a convolution computation on the received input characteristic diagram and the convolution kernel, and transmit an output characteristic diagram generated by the computation back to the storage module. In addition, the instruction generated by the instruction generation apparatus is further transmitted to the storage module of the neural network processor, and is configured to control the storage module to store the received output characteristic diagram to a preset location.

In an embodiment, as shown in FIG. 2, the instruction generation apparatus may include a retrieval instruction transmitting module 100, a matrix instruction transmitting module 200, and a storage instruction transmitting module 300.

The retrieval instruction transmitting module 100 is configured to acquire a retrieval decoding signal corresponding to a target neural network, and generate a retrieval instruction according to the retrieval decoding signal. The retrieval instruction is configured to control a neural network processor to acquire, according to the retrieval instruction, an input characteristic diagram and a convolution kernel.

The retrieval decoding signal corresponding to the target neural network refers to a computer-executable retrieval code signal formed by compiling an external retrieval program.

For example, the external retrieval program may be represented as:
for k in [0, K):
for p in [0, P):
for y in [0, KY):,
   where K represents a width of the input characteristic diagram; k represents the k-th element of the width of the input characteristic diagram performing a current retrieval operation; P represents a height of the input characteristic diagram; p represents the p-th element of the height of the input characteristic diagram performing the current retrieval operation; KY represents a weight matrix corresponding to the convolution kernel; and y represents the p-th element in the convolution kernel performing the current retrieval operation.

The retrieval decoding signal formed by compiling the external retrieval program may be represented as:
load.exec Ifmap
load.exec Weight,
   where the load instruction is configured to load data from an external memory into a computer memory for use by the retrieval instruction transmitting module 100. The exec instruction is configured to execute a load instruction for a prefix. The Ifmap indicates the input characteristic diagram. The Weight represents a weight matrix corresponding to the convolution kernel.

The matrix instruction transmitting module 200 is configured to acquire a matrix decoding signal corresponding to a target neural network, and generate a matrix computation instruction according to the matrix decoding signal. The matrix computation instruction is configured to control the neural network processor to perform, according to the matrix computation instruction, an operation of a convolution computation on the input characteristic diagram and the convolution kernel.

The matrix decoding signal corresponding to the target neural network refers to a computer-executable matrix computation code signal formed by compiling an external matrix computation program.

For example, the external matrix computation program may be represented as:
O represents an output characteristic diagram obtained by performing a current matrix computation operation; I represents an input characteristic diagram for performing the current matrix computation operation; W represents a convolution kernel for performing the current matrix computation operation; and j represents a processing variable of the neural network processor. When the neural network processor includes 8×8×8 INT8 multipliers, it indicates that the neural network processor may process a matrix multiplication operation of one 8×8 matrix by another 8×8 matrix in one cycle, and in this case, a value range of j is [0, 8].

The matrix decoding signal formed by compiling the external matrix computation program may be represented as:
mat.exec,
   where the mat instruction may be configured to perform a matrix operation, such as matrix addition, multiplication, transposition, inverse computation, and eigenvalue computation, etc. Specific syntax and supported operations depend on a programming language or a mathematical database used, which is not limited in the present disclosure.

The storage instruction transmitting module 300 is configured to acquire a storage decoding signal corresponding to a target neural network, and generate a storage instruction according to the storage decoding signal. The storage instruction is configured to control the neural network processor to store an output characteristic diagram corresponding to the target neural network to a target address.

The storage decoding signal refers to a computer-executable storage code signal formed by compiling an external program.

For example, the external program may be an output object O[k][p] specified in the above-mentioned matrix computation program, and the storage decoding signal formed by compiling the external program may be represented as:
store.exec Ofmap,
   where Ofmap represents an output characteristic diagram.

With the instruction generation apparatus provided in the above embodiment, the retrieval decoding signal corresponding to the target neural network is acquired. The retrieval instruction is generated according to the retrieval decoding signal, the retrieval instruction is configured to control the neural network processor to acquire, according to the retrieval instruction, the input characteristic diagram and the convolution kernel; the matrix decoding signal is acquired; the matrix computation instruction is generated according to the matrix decoding signal, and the matrix computation instruction is configured to control the neural network processor to perform, according to the matrix computation instruction, the operation of convolution computation on the input characteristic diagram and the convolution kernel; the storage decoding signal is acquired; the storage instruction is generated according to the storage decoding signal, the storage instruction is configured to control the neural network processor to store the output characteristic diagram corresponding to the target neural network to the target address. In such a manner, the retrieval instruction transmitting module 100, the matrix instruction transmitting module 200, and the storage instruction transmitting module 300 in the embodiment may generate control instructions in parallel, to control the neural network processor to perform retrieval, computation and storage operations respectively, thereby avoiding the problem of lower efficiency caused by the control apparatus transmitting the control instructions one by one to the neural network processor to control the processor to perform the operations group by group in the conventional technology, and accordingly effectively improving the efficiency of controlling the neural network processor to process the neural network operations.

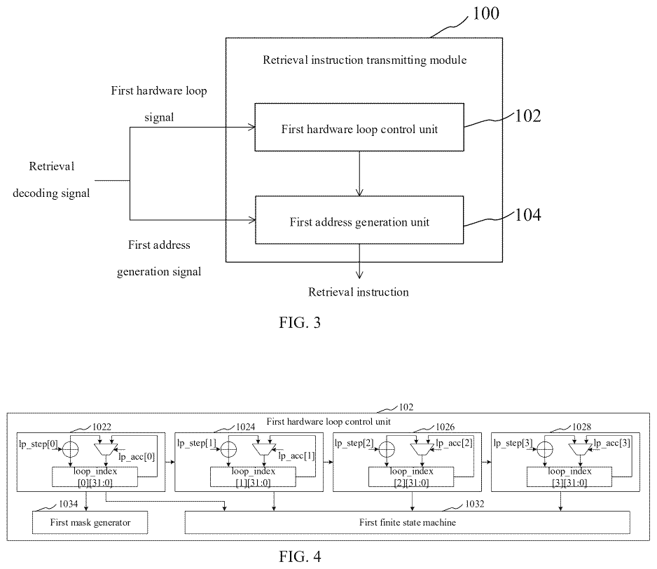

In an embodiment, based on the embodiment shown in FIG. 2, as shown in FIG. 3, the retrieval instruction transmitting module 100 includes a first hardware loop control unit 102 and a first address generation unit 104, and the retrieval decoding signal includes a first hardware loop signal and a first address generation signal.

The first hardware loop signal refers to a signal in the retrieval decoding signal for configuring a parameter for the first hardware loop control unit 102 to execute a first hardware loop process, and includes a starting value, an ending value, and a step size.

For example, the first hardware loop signal may be represented as:
load.loop[1] 0, 8, 8,
   where the loop[1] instruction indicates a parameter setting for performing a level-1 first hardware loop process, and the above-mentioned first hardware loop signal indicates that a starting value of the level-1 first hardware loop process is equal to 0, a step size is equal to 8, and an ending value is equal to 8.

The first address generation signal refers to a signal in the retrieval decoding signal for configuring a parameter for the first address generation unit 104 to execute a first address generation process.

For example, the first address generation signal may be represented as:
load.opstep[1] 8, x, x
load.exec,
   where the opstep instruction is configured to set an address step size in the first address generation process. The first address generation signal load.opstep[1] indicates that an address step size corresponding to the level-1 first address generation process is equal to 8. The load.exec indicates that the level-1 first address generation process is performed according to the parameter setting of the load.opstep[1] signal.

The first hardware loop control unit 102 is configured to acquire a first hardware loop signal, perform a first hardware loop process according to the first hardware loop signal, and obtain a first sequence group and a first mask sequence.

The first hardware loop processes may have a plurality of levels. The first sequence group is obtained according to loop results of first hardware loop processes of the plurality of levels. An element in the first mask sequence is obtained by means of computation according to a loop result of the 0 th-level loop process.

For example, the first hardware loop process may have three levels, and the first hardware loop signal may be represented as:
load.loop[2] 0, P, 1
load.loop[1] 0, KY, 1
load.loop[0] 0, 8, 8

It may be obtained that a first sequence of the first sequence group is [0, 0, 0], respectively corresponding to starting values of the level-2, level-1, and level-0 first hardware loop processes. The first value of the first mask sequence corresponds to the starting value of the level-0 first hardware loop process. If one first hardware loop process is performed, it is obtained that a second sequence of the first sequence group is [0, 1, 0], respectively corresponding to loop results of current level-2, level-1, and level-0 loop processes, and a second value of the first mask sequence corresponds to a loop result of the current level-0 loop process.

The first address generation unit 104 is configured to acquire a first address generation signal, a first sequence group, and a first mask sequence, perform a first address generation process according to the first address generation signal, the first sequence group, and the first mask sequence, and obtain a retrieval instruction.

Exemplarily, when the neural network processor includes 8×8×8 INT8 multipliers, it indicates that the neural network processor may process a matrix multiplication operation of an 8×8 matrix multiplied by another 8×8 matrix in one cycle. In such a manner, the storage module of the neural network processor may accept eight addresses generated by the first address generation unit 104 as a retrieval instruction, and control the storage module to acquire an input characteristic diagram and a convolution kernel according to the addresses corresponding to the retrieval instruction. The first address generation unit 104 sets an address step size in the first address generation process according to the first address generation signal, and obtains eight addresses as a retrieval instruction according to a first address generation formula based on the address step size, the first sequence group, and the first mask sequence.

In the embodiment, the first hardware loop control unit 102 in the retrieval instruction transmitting module 100 is configured to acquire a first hardware loop signal in the retrieval decoding signal, perform a first hardware loop process according to the first hardware loop signal, and obtain a first sequence group and a first mask sequence. The first address generation unit 104 is configured to obtain the retrieval instruction according to the first address generation signal in the retrieval decoding signal, the first sequence group, and the first mask sequence. In such a manner, the retrieval instruction transmitting module 100 independently generates the retrieval instruction according to the retrieval decoding signal, and is configured to independently control the storage unit of the neural network processor to acquire the input characteristic diagram and the convolution kernel, so that the neural network processor can enter the current retrieval process after completing the previous retrieval process, thereby improving the efficiency of the neural network processor processing the neural network operations.

In an embodiment, as shown in FIG. 4, the first hardware loop control unit 102 may include a first accumulator 1022, a second accumulator 1024, a third accumulator 1026, a fourth accumulator 1028, a first finite state machine 1032, and a first mask generator 1034. The first hardware loop signal may include a first accumulation signal, a second accumulation signal, a third accumulation signal, and a fourth accumulation signal.

The first accumulator 1022 is configured to acquire a first accumulation signal, perform first accumulation operations according to the first accumulation signal, and output a first accumulation result corresponding to each first accumulation operation to the first finite state machine 1032 and the first mask generator 1034.

The first accumulation signal refers to a signal in the first hardware loop signal for configuring a parameter for the first accumulator 1022, and includes a starting value, an ending value, and a step size.

For example, the first accumulation operation performed by the first accumulator 1022 can be set to correspond to the level-0 first hardware loop process of the first hardware loop control unit 102, and the first accumulation signal may be denoted as:
load.loop[0] 0, 8, 8, where a starting value of the first accumulation operation performed by the first accumulator 1022 is 0, an ending value is 8, and a step size is 8. The starting value 0 serves as a first accumulation result of the 0-th first address generation process and is outputted to the first finite state machine 1032 and the first mask generator 1034. In the 1-st first address generation process, the first accumulation operation is performed and an ending value of the first accumulation operation is reached, the first accumulation result returns to the starting value 0, and the first accumulation result is outputted to the first finite state machine 1032 and the first mask generator 1034.

The second accumulator 1024 is configured to acquire a second accumulation signal and first accumulation results, perform second accumulation operations according to the second accumulation signal and the first accumulation results, and output a second accumulation result corresponding to each second accumulation operation to the first finite state machine 1032.

The second accumulation signal refers to a signal in the first hardware loop signal for configuring a parameter for the second accumulator 1024, and includes a starting value, an ending value, and a step size.

For example, the second accumulation operation performed by the second accumulator 1024 can be set to correspond to the level-1 first hardware loop operation of the first hardware loop control unit 102, and the second accumulation signal may be represented as:
load.loop[1] 0, 3, 1,
   where a starting value of the second accumulation operation performed by the second accumulator 1024 is 0, an ending value is 3, and a step size is 1, and the starting value 0 serves as a second accumulation result of the 0-th first address generation process and is outputted to the first finite state machine 1032. If the first accumulation result reaches the ending value of the first accumulation operation, the second accumulator 1024 may perform the second accumulation operation. After one second accumulation operation is performed, the second accumulation result of 1 can be obtained, not reaching the ending value of the second accumulation operation, and the second accumulation result is outputted to the first finite state machine 1032.

The third accumulator is configured to acquire a third accumulation signal and second accumulation results, perform third accumulation operations according to the third accumulation signal and the second accumulation results, and output a third accumulation result corresponding to each third accumulation operation to the first finite state machine.

The third accumulation signal refers to a signal in the first hardware loop signal for configuring a parameter for the third accumulator 1026, and includes a starting value, an ending value, and a step size.

For example, the third accumulation operation performed by the third accumulator 1026 may be set to correspond to the level-2 first hardware loop process of the first hardware loop control unit 102, and the third accumulation signal may be represented as:
load.loop[2] 0, 3, 1,
   where a starting value of the third accumulation operation performed by the third accumulator 1026 is 0, an ending value is 3, and a step size is 1, and the starting value 0 serves a third accumulation result of the 0-th first address generation process and is outputted to the first finite state machine 1032.

If the second accumulation result does not reach the ending value of the second accumulation operation, the third accumulation operation is not started, and the starting value of the third accumulation operation is outputted to the first finite state machine 1032 as the third accumulation result of the current level-2 first hardware loop process.

If the second accumulation result reaches the ending value of the second accumulation operation, the third accumulator 1026 performs the third accumulation operation. After one third accumulation operation is performed, the third accumulation result of 1 can be obtained, not reaching the ending value of the third accumulation operation, and the third accumulation result is outputted to the first finite state machine 1032.

The fourth accumulator is configured to acquire a fourth accumulation signal and third accumulation results, perform fourth accumulation operations according to the fourth accumulation signal and the third accumulation results, and output a fourth accumulation result corresponding to each fourth accumulation operation to the first finite state machine.

The fourth accumulation signal refers to a signal in the first hardware loop signal for configuring a parameter for the fourth accumulator 1028, and includes a starting value, an ending value, and a step size.

For example, the fourth accumulation operation performed by the fourth accumulator 1028 may be set to correspond to the level-3 first hardware loop process of the first hardware loop control unit 102, and the third accumulation signal may be represented as:
load.loop[3] 0, 8, 1,
   where a starting value of the fourth accumulation operation performed by the fourth accumulator 1028 is 0, an ending value is 8, and a step size is 1, and the starting value 0 serves as the fourth accumulation result of the 0-th first address generation process and is outputted to the first finite state machine 1032.

If the third accumulation result does not reach the ending value of the third accumulation operation, the fourth accumulation operation is not started, and the starting value of the fourth accumulation operation is outputted to the first finite state machine 1032 as the fourth accumulation result of the current level-3 first hardware loop process.

If the third accumulation result reaches the ending value of the third accumulation operation, the fourth accumulator 1028 performs the fourth accumulation operation, and after one fourth accumulation operation is performed, a fourth accumulation result of 1 can be obtained, not reaching the ending value of the fourth accumulation operation, and the fourth accumulation result is outputted to the first finite state machine 1032.

The first finite state machine 1032 is configured to obtain a first sequence group according to the first accumulation results, the second accumulation results, the third accumulation results, and the fourth accumulation results.

The first sequence group refers to a set of sequences obtained according to the first accumulation results, the second accumulation results, the third accumulation results, and the fourth accumulation results.

For example, in the 0-th first address generation process, the first accumulation result, the second accumulation result, the third accumulation result, and the fourth accumulation result are all 0, and a first value of the first sequence group may be obtained as [0, 0, 0, 0], respectively corresponding to the starting values of level-3, level-2, level-1, and level-0 first hardware loop processes.

In the 1-st first address generation process, the first accumulator 1022 performs the first accumulation operation and the ending value of the first accumulation operation is reached, and the first accumulator 1022 returns to the starting value 0. The second accumulator 1024 performs the second accumulation operation and a second accumulation result of 1 is obtained. The third accumulator 1026 and the fourth accumulator 1028 do not perform accumulation operations. A second value of the first sequence group may be obtained as [0, 0, 1, 0], respectively corresponding to a fourth accumulation result of the level-3 first hardware loop process, a third accumulation result of the level-2 first hardware loop process, a second accumulation result of the level-1 first hardware loop process, and a first accumulation result of the level-0 first hardware loop process.

The first mask generator 1034 is configured to obtain a first mask sequence according to the first accumulation results.

Each value in the first mask sequence is determined according to each first accumulation result obtained by the first accumulator 1022 in each first address generation process.

In the embodiment, the first hardware loop control unit may include four accumulators, so that four levels of first hardware loop processes can be implemented. Start and stop of an accumulator corresponding to a current level first hardware loop process is controlled according to an accumulation result of an accumulator corresponding to a previous level first hardware loop process, and a first sequence group is obtained according to the accumulation result of each level loop process. In such a manner, only four accumulators are required to quickly generate a first sequence group including a plurality of sequences, which can be configured to generate a plurality of retrieval instructions, thereby further reducing the size of the retrieval decoding signal, improving the efficiency of generating a retrieval instruction, and accordingly improving the efficiency of controlling the neural network processor to process the neural network operations.

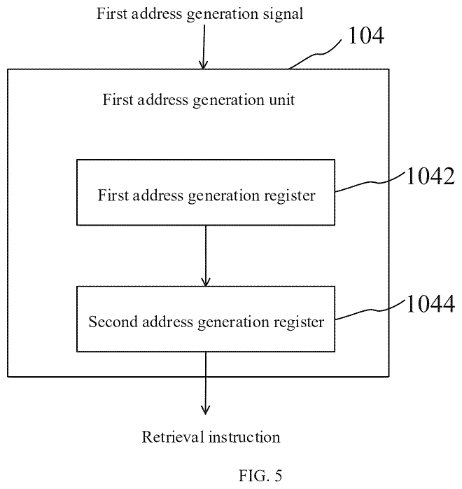

In an embodiment, as shown in FIG. 5, the first address generation signal may include an input characteristic diagram address, a convolution kernel address, a first address step size, an up-sampling enable signal, and a fill signal. The first address generation unit 104 may include a first address generation register 1042 and a second address generation register 1044.

The first address step size may include a step size of an input characteristic diagram address and a step size of a convolution kernel address. The up-sampling enable signal and the fill signal are determined according to an actual situation of the neural network processor. If the neural network processor uses the up-sampling operation when processing the target neural network, the up-sampling enable signal is 1; otherwise, the up-sampling enable signal is 0. If the neural network processor performs a fill operation when processing the target neural network, the fill signal is 1; otherwise, the fill signal is 0.

The first address generation register 1042 is configured to acquire an input characteristic diagram address and a convolution kernel address, and generate a first base address according to the input characteristic diagram address and the convolution kernel address.

The first base address is reset at the input characteristic diagram address and the convolution kernel address.

For example, the first address generation register 1042 acquires the input characteristic diagram address KP and the convolution kernel address KY, and sets the first base address to 0 based on the KP and KY.

For example, the first address generation register 1042 may be a ScratchPad Memory (SPM).

The second address generation register 1044 is configured to acquire a first address step size, an up-sampling enable signal, a fill signal, a first base address, a first sequence group, and a first mask sequence, and obtain a retrieval instruction according to the first address step size, the up-sampling enable signal, the fill signal, the first base address, the first sequence group, and the first mask sequence.

The retrieval instruction is obtained by the second address generation register 1044 by performing the following processing on the first address step size, the up-sampling enable signal, the fill signal, the first base address, the first sequence group, and the first mask sequence:
the second address generation register 1044 obtains a first loop address loop_addr according to the first address step size opstep[i], the first base address base_addr, the first sequence group {loop_index[i]}, and the up-sampling enable signal upsample_en[i]. The specific computation may be expressed as follows:
   where i represents a level number of the first hardware loop process, and has a value range of [0, 3], oft[i] represents a parity of i, oft[i]=1 when i is an odd number, and oft[i]=0 when i is an even number, and the first loop address loop_addr may be represented in a binary form.

The second address generation register 1044 obtains, according to the first mask sequence pad_mask[i] and the first loop address loop_addr, a retrieval instruction number stride_id[n] generated in a first hardware loop process. The specific computation process may be expressed as follows:
where a value range of n is determined according to an actual situation of the neural network processor. The retrieval instruction number stride_id[n] may be represented in a binary form.

For one first hardware loop process, the second address generation register 1044 determines a first address hopping quantity stride_step[n] according to the retrieval instruction number stride_id[n].

If the retrieval instruction number stride_id[n] is greater than or equal to 0, and the third bit and the fourth bit of the retrieval instruction number stride_id[n] in the binary form are both 0, the first address hopping quantity stride_step[n] is determined as 0.

If the retrieval instruction number stride_id[n] is greater than or equal to 0, and the third bit and the fourth bit of the retrieval instruction number stride_id[n] in the binary form are not all 0, the first address hopping quantity stride_step[n] is determined according to the fourth bit of the retrieval instruction number stride_id[n] in the binary form and the first address step size.

If the retrieval instruction number stride_id[n] is less than 0, the first address hopping quantity stride_step[n] is determined according to an opposite number of the first address step size.

For one first hardware loop process, the second address generation register 1044 determines a middle address middle_addr[n] according to the first sequence group {loop_index[i]}ₙ and the retrieval instruction number stride_id[n]. The third bit to the twelfth bit of the middle address middle_addr[n] are determined by the first loop address loop_addr, and the 0-th bit to the second bit are determined by the retrieval instruction number stride_id[n]. A summation processing is performed on the middle address middle_addr[n] and the first address hopping quantity stride_step[n], and the retrieval instruction addr[n] is obtained. The above may be represented as follows:

In a feasible implementation mode, the second address generation register 1044 may be a Vector Register File (VRF) memory.

In the embodiment, the first address generation register 1042 in the first address generation unit 104 is configured to acquire an input characteristic diagram address and a convolution kernel address, and generate a first base address according to the input characteristic diagram address and the convolution kernel address. The second address generation register 1044 is configured to acquire a first address step size, an up-sampling enable signal, a fill signal, a first base address, a first sequence group, and a first mask sequence, and obtain a retrieval instruction according to the first address step size, the up-sampling enable signal, the fill signal, the first base address, the first sequence group, and the first mask sequence. In such a manner, in the process of generating the retrieval instruction, the first address generation unit 104 involves two neural network processing manners, i.e., the up-sampling and the fill, so that the retrieval instruction in the embodiment has a wider control range over the neural network processor, thereby expanding an application range of the instruction generation apparatus in the embodiment.

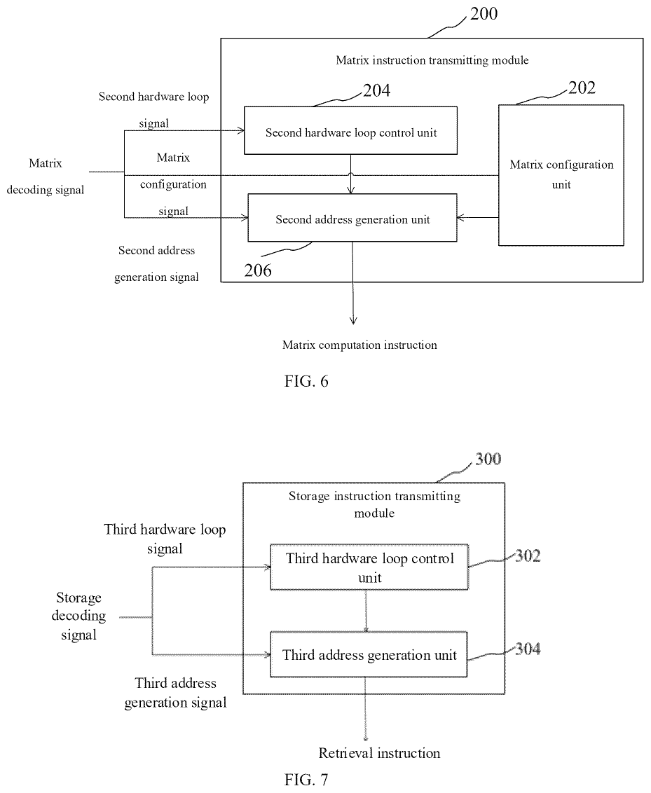

In an embodiment, as shown in FIG. 6, the matrix instruction transmitting module 200 includes a matrix configuration unit 202, a second hardware loop control unit 204, and a second address generation unit 206. A matrix decoding signal may include a second hardware loop signal, a second address generation signal, and a matrix configuration signal.

The matrix configuration unit 206 is configured to acquire a matrix configuration signal, and generate a matrix configuration result according to the matrix configuration signal.

As an example, the matrix configuration signal may be represented as:
mat.config.bs 64, x, x
   where the config instruction may be configured to configure a numbering system and a data format in a matrix execution module, bs in the matrix configuration signal represents the binary, and 64 represents that a maximum step size of the data format is 64.

The second hardware loop control unit 204 is configured to acquire a second hardware loop signal, perform a second hardware loop process according to the second hardware loop signal, and obtain a second sequence group and a second mask sequence.

A structure of the second hardware loop control unit 204 is the same as that of the first hardware loop control unit 102. A second hardware loop process may have a plurality of levels. Each level of the second hardware loop process is controlled by one accumulator. Start and stop of an accumulator corresponding to a current level of the second hardware loop process are controlled according to an accumulation result of an accumulator corresponding to a previous level of the second hardware loop process, and a second sequence group is obtained according to an accumulation result of each level of the second hardware loop process. The second mask sequence is obtained by computation according to loop results of the 0-th loops of the multiple second hardware loop processes.

In a feasible implementation mode, the second hardware loop process may have four levels. For example, the second hardware loop signal may be represented as:
mat.loop[3] 0, 8, 1
mat.loop[2] 0, 3, 1
mat.loop[1] 0, 3, 1
mat.loop[0] 0, 8, 8,
   where the mat.loop[0] instruction indicates to perform a parameter setting for the level-0 second hardware loop process, and the second hardware loop signal indicates that a starting value of the level-0 second hardware loop process is 0, a step size is 8, and an ending value is 8.

A first sequence of the second sequence group can be obtained as [0, 0, 0, 0], respectively corresponding to a start value of a level-3, level-2, level-1, and level-0 first hardware loop process, and a first value of the second mask sequence corresponds to a starting value of the level-0 second hardware loop process. If one second hardware loop process is performed, a second sequence of the second sequence group is obtained as [0, 0, 1, 0], respectively corresponding to a loop result of the current level-3, level-2, level-1, and level-0 loop process, and a second value of the second mask sequence corresponds to a loop result of the current level-0 loop process.

The second address generation unit 206 is configured to acquire a matrix configuration result, a second sequence group, a second mask sequence, and a second address generation signal, perform a second address generation process according to the matrix configuration result, the second sequence group, the second mask sequence, and the second address generation signal, and obtain a matrix computation instruction.

A structure of the second address generation unit 206 is the same as that of the first address generation unit 104, and includes a third address generation register and a fourth address generation register.

The second address generation signal may include an input characteristic diagram address, a convolution kernel address, a second address step size, an up-sampling enable signal, and a fill signal.

The third address generation register is configured to acquire an input characteristic diagram address and a convolution kernel address, and generate a second base address according to the input characteristic diagram address and the convolution kernel address.

The fourth address generation register is configured to acquire a matrix configuration result, a second address step size opstep[j], an up-sampling enable signal upsample_en[j], a fill signal pad, a second base address base_addr, a second sequence group {loop_index₂[j]}, and a second mask sequence pad_mask₂[j], and obtain a matrix computation instruction according to the above data.

A specific computation may be expressed as follows:

where j represents a level number of the second hardware loop process, a value range is [0, 3], oft[j] represents a parity of j, and the second loop address loop_addr is represented in a binary form according to the matrix configuration result. where the value range of t is determined according to an actual situation of the neural network processor. The matrix computation instruction number stride_id[t] is represented in the binary form according to the matrix configuration result.
where big_step refers to a maximum step size in the matrix configuration signal.

Example 1: when the neural network processor includes 8×8×8 INT8 multipliers, it indicates that the neural network processor may process a matrix multiplication operation of one 8×8 matrix by another 8×8 matrix in one cycle. In such a manner, a storage module of the neural network processor may accept eight addresses as a matrix calculation instruction, and supply the eight addresses to the matrix computation module for computation, that is, the value range of t is [0, 7].

The second address generation signal may be represented as:
mat.opstep[3] 48, x, x
mat.opstep[2] 16, x, x
mat.opstep[1] 8, x, x
mat.opstep[0] 1, x, x
mat.exec 0, x, x
   where the third address generation register sets the second base address base_addr to 0, the second address step size opstep₂[j]=[48, 16, 8, 1], and big_step to 64 on the basis of the input characteristic diagram address and the convolution kernel address.

When one sequence in the second sequence groups is [1, 1, 2, 0],

$${loop\_addr}_{2} = 0 + 1 \times 48 + 1 \times 16 + \times 8 = 80 ;$$

$${stride\_id}_{2} [ t ] = 0 + ( t - 0 ) \times 1 = t ;$$

$${stride\_step}_{2} [ t ] = 0 ; {addr}_{2} [ t ] = 80 + t + 0 = 80 + t ;$$

in this case, the matrix computation instruction is obtained as [87, 86, 85, 84, 83, 82, 81, 80].

Example 2: when the neural network processor processes the target neural network in a fill manner, the fill signal is set to 1 and other settings are the same as the example 1, and when one sequence in the second sequence group is [1, 1, 2, 0],

$${loop\_addr}_{2} = 0 + 1 \times 48 + 1 \times 16 + 2 \times 8 = 80 ;$$

$$stride\_id2 [ t ] = 0 + ( t - 1 ) \times 1 = t - 1 ;$$

$${stride\_step}_{2} : {stride\_step}_{2} [ 0 ] = - 64 ; {stride\_step}_{2} [ t ] = 0$$

$${addr}_{2} : {addr}_{2} [ 0 ] = 80 - 64 = 16 ;$$

$${addr}_{2} [ t ] = 80 + ( t - 1 ) + 0 = 79 + t ;$$

in this case, the matrix computation instruction is [86, 85, 84, 83, 82, 81, 80, 16]. Since the first number is filled, an instruction corresponding to the first number will be discarded.

Example 3: when the neural network processor processes the target neural network in the up-sampling mode, the up-sampling enable signals of level-1 and level-0 loop processes are set to 1, and other settings are the same as the example 1. When one sequence in the second sequence group is [1, 1, 2, 0], oft₂ of the level-1 loop process is equal to 1.

$${loop\_addr}_{2} = 0 + 1 \times 48 + 1 \times 16 + ( 2 + 1 ) \times 8 >> 1 = 0 + 48 + 16 + 8 = 72 ;$$

$${stride\_id}_{2} [ t ] = 0 + t \times 1 >> 1 ; {stride\_id}_{2} [ t ] = 0 ;$$

$${addr}_{2} [ t ] = 72 + t \times 1 >> 1 + 0 ;$$

in this case, the matrix computation instruction is [75, 75, 74, 74, 73, 73, 72, 72].

Example 4: when the matrix instruction transmitting module needs to transmit an instruction to control the neural network processor to process a target neural network, a sliding step size of the convolution kernel is equal to 2, and a level-0 loop of the second address generation signal may be represented as: mat.opstep[0] 2, x, x. Other settings are the same as the example 1. When one sequence in the second sequence group is [1, 1, 2, 0],

$${loop\_addr}_{2} = 0 + 1 \times 48 + 1 \times 16 + 1 \times 16 = 80 ;$$

$${stride\_id}_{2} [ t ] = 0 + t \times 2 , t = 0 , 1 , 2 , 3 , 4 , 5 , 6 , 7 ;$$

$$when {stride\_step}_{2} : t = [ 0 , 3 ] , {stride\_step}_{2} [ t ] = 0 ;$$

$$when t = [ 4 , 7 ] , {stride\_step}_{2} [ t ] = big\_step = 64 ;$$

$$when {addr}_{2} : t = [ 0 , 3 ] , {addr}_{2} [ t ] = 80 + t \times 2 ;$$

$$when t = [ 4 , 7 ] , {addr}_{2} [ t ] = 80 + ( t \times 2 - 8 ) + 64 = 136 + t \times 2 ;$$

in this case, the matrix computation instruction may be obtained as [150, 148, 146, 144, 86, 84, 82, 80].

In the above embodiment, the matrix configuration unit included in the matrix instruction transmitting module is configured to acquire a matrix configuration signal, and generate, according to the matrix configuration signal, a matrix configuration result for controlling a numbering system and a shape of each piece of data in the second hardware loop control unit and the second address generation unit. In such a manner, different matrix configuration signals can be set, so that the matrix computation instruction transmitted by the matrix instruction transmitting module can be adapted to the neural network processor in different scenarios, thereby expanding the application scenarios of the instruction generation apparatus.

In an embodiment, as shown in FIG. 7, the storage decoding signal may include a third hardware loop signal and a third address generation signal. The storage instruction transmitting module 300 may include a third hardware loop control unit 302 and a third address generation unit 304.

The third hardware loop control unit 302 is configured to acquire a third hardware loop signal, perform a third hardware loop process according to the third hardware loop signal, and obtain a third sequence group and a third mask sequence.

A structure of the third hardware loop control unit 302 is the same as that of the first hardware loop control unit 102.

The third address generation unit 304 is configured to acquire a third sequence group and a third address generation signal, perform a third address generation process according to the third address generation signal, the third sequence group, and the third mask sequence, and obtain a storage instruction.

A structure of the third address generation unit 304 is the same as that of the first address generation unit 104.

In the above embodiment, the storage instruction transmitting module 300 is configured to independently generate, according to the storage decoding signal, a storage instruction for independently controlling a storage unit of the neural network processor to perform an operation of storing an output characteristic diagram, so that the neural network processor can enter a current storage process after completing a previous storage process, thereby improving the efficiency of controlling the neural network processor to process a neural network operation.

In an embodiment, an instruction generation method is provided, and the method may include:
a retrieval decoding signal is acquired, a retrieval instruction is generated according to the retrieval decoding signal, the retrieval instruction is configured to control a neural network processor to acquire, according to the retrieval instruction, an input characteristic diagram and a convolution kernel; a matrix decoding signal is acquired, a matrix computation instruction is generated according to the matrix decoding signal, the matrix computation instruction is configured to control the neural network processor to perform, according to the matrix computation instruction, an operation of a convolution computation on the input characteristic diagram and the convolution kernel; a storage decoding signal is acquired, a storage instruction is generated according to the storage decoding signal, the storage instruction is configured to control the neural network processor to store an output characteristic diagram corresponding to the target neural network to a target address.

In an embodiment, the retrieval decoding signal includes a first hardware loop signal and a first address generation signal. The retrieval instruction transmitting module includes a first hardware loop control unit and a first address generation unit. A first hardware loop process is performed according to the first hardware loop signal, a first sequence group and a first mask sequence are obtained; a first address generation process is performed according to the first address generation signal, the first sequence group, and the first mask sequence, and a retrieval instruction is obtained.

In an embodiment, the first hardware loop signal may include a first accumulation signal, a second accumulation signal, a third accumulation signal, and a fourth accumulation signal; a first accumulation operation is performed according to the first accumulation signal, and a first accumulation result corresponding to each first accumulation operation is outputted; a second accumulation operation is performed according to the second accumulation signal and the first accumulation result, and a second accumulation result corresponding to each second accumulation operation is outputted; a third accumulation operation is performed according to the third accumulation signal and the second accumulation result, and a third accumulation result corresponding to each third accumulation operation is outputted; a fourth accumulation operation is performed according to the fourth accumulation signal and the third accumulation result, and a fourth accumulation result corresponding to each fourth accumulation operation is outputted; a first sequence group is obtained according to each first accumulation result, each second accumulation result, each third accumulation result, and each fourth accumulation result; and a first mask sequence is obtained according to each first accumulation result.

In an embodiment, the first address generation signal may include an input characteristic diagram address, a convolution kernel address, a first address step size, an up-sampling enable signal, and a fill signal; a first base address is generated according to the input characteristic diagram address and the convolution kernel address; and a retrieval instruction is obtained according to the first address step size, the up-sampling enable signal, the fill signal, the first base address, the first sequence group, and the first mask sequence.

In an embodiment, the matrix decoding signal may include a second hardware loop signal, a second address generation signal, and a matrix configuration signal; a matrix configuration result is generated according to the matrix configuration signal; a second hardware loop process is performed according to the second hardware loop signal, and a second sequence group and a second mask sequence are obtained; a second address generation process is performed according to the matrix configuration result, the second sequence group, the second mask sequence, and the second address generation signal, and a matrix computation instruction is obtained.

In an embodiment, the storage decoding signal may include a third hardware loop signal and a third address generation signal; a third hardware loop process is performed according to the third hardware loop signal, a third sequence group and a third mask sequence are obtained; a third address generation process is performed according to the third address generation signal, the third sequence group, and the third mask sequence, and a storage instruction is obtained.

In an embodiment, a computer device is provided, including the instruction generation apparatus in the above-mentioned apparatus embodiments.

In an embodiment, a computer-readable storage medium is provided, on which a computer program is stored. The computer program, when being executed by a processor, may cause the processor to implement the steps in the above-mentioned method embodiments.

In an embodiment, a computer program product is provided, including a computer program. The computer program, when being executed by a processor, may cause the processor to implement the steps in the above-mentioned method embodiments.

In the description of the specification, the description involving the terms “some embodiments”, “other embodiments”, “ideal embodiments”, and the like means that specific features, structures, materials, or features described with reference to the embodiments or examples are included in at least one embodiment or example of the present disclosure. In the specification, a schematic description of the foregoing terms does not definitely refer to the same embodiment or example.

The technical features in the above-mentioned embodiments may be combined in any manner. For simplicity of description, all possible combinations of the technical features in the above-mentioned embodiments are not described. However, as long as there is no contradiction between the combinations of the technical features, these combinations should be considered as the scope of the present disclosure.

The aforementioned embodiments represent only some implementation modes of the present disclosure, and description thereof is relatively specific and detailed, but may not be construed as a limitation on the scope of the present disclosure. It should be noted that a person of ordinary skill in the art may make some modifications and improvements without departing from the concept of the present disclosure, which all fall within the protection scope of the present disclosure. Therefore, the protection scope of the present disclosure shall be subject to the appended claims.

1. An instruction generation apparatus, comprising:
a retrieval instruction transmitting module, a matrix instruction transmitting module, and a storage instruction transmitting module; wherein
the retrieval instruction transmitting module is configured to acquire a retrieval decoding signal corresponding to a target neural network, and generate a retrieval instruction according to the retrieval decoding signal, wherein the retrieval instruction is configured to control a neural network processor to acquire, according to the retrieval instruction, an input characteristic diagram and a convolution kernel;
the matrix instruction transmitting module is configured to acquire a matrix decoding signal corresponding to the target neural network, and generate a matrix computation instruction according to the matrix decoding signal, wherein the matrix computation instruction is configured to control the neural network processor to perform, according to the matrix computation instruction, an operation of a convolution computation on the input characteristic diagram and the convolution kernel;
the storage instruction transmitting module is configured to acquire a storage decoding signal corresponding to the target neural network, and generate a storage instruction according to the storage decoding signal, wherein the storage instruction is configured to control the neural network processor to store an output characteristic diagram corresponding to the target neural network to a target address.

2. The apparatus according to claim 1, wherein the retrieval decoding signal includes a first hardware loop signal and a first address generation signal, and the retrieval instruction transmitting module includes a first hardware loop control unit and a first address generation unit;
the first hardware loop control unit is configured to acquire the first hardware loop signal, perform a first hardware loop process according to the first hardware loop signal, and obtain a first sequence group and a first mask sequence;
the first address generation unit is configured to acquire the first address generation signal, the first sequence group and the first mask sequence, perform a first address generation process according to the first address generation signal, the first sequence group and the first mask sequence, and obtain the retrieval instruction.

3. The apparatus according to claim 2, wherein the first hardware loop signal includes a first accumulation signal, a second accumulation signal, a third accumulation signal, and a fourth accumulation signal; the first hardware loop control unit includes a first accumulator, a second accumulator, a third accumulator, a fourth accumulator, a first finite state machine, and a first mask generator;
the first accumulator is configured to acquire the first accumulation signal, perform first accumulation operations according to the first accumulation signal, and output a first accumulation result corresponding to each first accumulation operation to the first finite state machine and the first mask generator;
the second accumulator is configured to acquire the second accumulation signal and first accumulation results, perform second accumulation operations according to the second accumulation signal and the first accumulation results, and output a second accumulation result corresponding to each second accumulation operation to the first finite state machine;
the third accumulator is configured to acquire the third accumulation signal and second accumulation results, perform third accumulation operations according to the third accumulation signal and the second accumulation results, and output a third accumulation result corresponding to each third accumulation operation to the first finite state machine;
the fourth accumulator is configured to acquire the fourth accumulation signal and third accumulation results, perform fourth accumulation operations according to the fourth accumulation signal and the third accumulation results, and output a fourth accumulation result corresponding to each fourth accumulation operation to the first finite state machine;
the first finite state machine is configured to obtain the first sequence group according to the first accumulation results, the second accumulation results, the third accumulation results, and the fourth accumulation results;
the first mask generator is configured to obtain the first mask sequence according to the first accumulation results.

4. The apparatus according to claim 3, wherein the first address generation signal includes an input characteristic diagram address, a convolution kernel address, a first address step size, an up-sampling enable signal, and a fill signal; the first address generation unit includes a first address generation register and a second address generation register;
the first address generation register is configured to acquire the input characteristic diagram address and the convolution kernel address, and generate a first base address according to the input characteristic diagram address and the convolution kernel address;
the second address generation register is configured to acquire the first address step size, the up-sampling enable signal, the fill signal, the first base address, the first sequence group and the first mask sequence, and obtain the retrieval instruction according to the first address step size, the up-sampling enable signal, the fill signal, the first base address, the first sequence group and the first mask sequence.

5. The apparatus according to claim 1, wherein the matrix decoding signal includes a second hardware loop signal, a second address generation signal, and a matrix configuration signal; the matrix instruction transmitting module includes a second hardware loop control unit, a second address generation unit, and a matrix configuration unit;
the matrix configuration unit is configured to acquire the matrix configuration signal, and generate a matrix configuration result according to the matrix configuration signal;
the second hardware loop control unit is configured to acquire a second hardware loop signal, perform a second hardware loop process according to the second hardware loop signal, and obtain a second sequence group and a second mask sequence;
the second address generation unit is configured to acquire the matrix configuration result, the second sequence group, the second mask sequence and the second address generation signal, perform a second address generation process according to the matrix configuration result, the second sequence group, the second mask sequence and the second address generation signal, and obtain the matrix computation instruction.

6. The apparatus according to claim 1, wherein the storage decoding signal includes a third hardware loop signal and a third address generation signal; the storage instruction transmitting module includes a third hardware loop control unit and a third address generation unit;
the third hardware loop control unit is configured to acquire the third hardware loop signal, perform a third hardware loop process according to the third hardware loop signal, and obtain a third sequence group and a third mask sequence;
the third address generation unit is configured to acquire the third sequence group and the third address generation signal, perform a third address generation process according to the third address generation signal, the third sequence group and the third mask sequence, and obtain the storage instruction.

7. An instruction generation method, comprising:
acquiring a retrieval decoding signal, and generating a retrieval instruction according to the retrieval decoding signal, wherein the retrieval instruction is configured to control a neural network processor to acquire, according to the retrieval instruction, an input characteristic diagram and a convolution kernel;
acquiring a matrix decoding signal, and generating a matrix computation instruction according to the matrix decoding signal, wherein the matrix computation instruction is configured to control the neural network processor to perform, according to the matrix computation instruction, an operation of a convolution computation on the input characteristic diagram and the convolution kernel; and
acquiring a storage decoding signal, and generating a storage instruction according to the storage decoding signal, wherein the storage instruction is configured to control the neural network processor to store an output characteristic diagram corresponding to a target neural network to a target address.

8. A computer device, comprising the instruction generation apparatus of claim 1.

9. A computer-readable storage medium, on which a computer program is stored, wherein the computer program, when executed by a processor, causes the processor to implement the method of claim 7.

10. A computer program product, comprising a computer program, wherein the computer program, when executed by a processor, causes the processor to implement the method of claim 7.

11. The instruction generation method according to claim 7, wherein the retrieval decoding signal includes a first hardware loop signal and a first address generation signal, and the method further comprises:
performing a first hardware loop process according to the first hardware loop signal, and obtaining a first sequence group and a first mask sequence;
performing a first address generation process according to the first address generation signal, the first sequence group, and the first mask sequence, and obtaining the retrieval instruction.

12. The instruction generation method according to claim 11, wherein the first hardware loop signal includes a first accumulation signal, a second accumulation signal, a third accumulation signal, and a fourth accumulation signal; and the method further comprises:
performing a first accumulation operation according to the first accumulation signal, outputting a first accumulation result corresponding to each first accumulation operation;
performing a second accumulation operation according to the second accumulation signal and the first accumulation result, outputting a second accumulation result corresponding to each second accumulation operation;
performing a third accumulation operation according to the third accumulation signal and the second accumulation result, outputting a third accumulation result corresponding to each third accumulation operation;
performing a fourth accumulation operation according to the fourth accumulation signal and the third accumulation result, outputting a fourth accumulation result corresponding to each fourth accumulation operation;
obtaining the first sequence group according to each first accumulation result, each second accumulation result, each third accumulation result, and each fourth accumulation result; and
obtaining the first mask sequence according to each first accumulation result.

13. The instruction generation method according to claim 11, wherein the first address generation signal includes an input characteristic diagram address, a convolution kernel address, a first address step size, an up-sampling enable signal, and a fill signal; and the method further comprises:
generating a first base address according to the input characteristic diagram address and the convolution kernel address; and
obtaining the retrieval instruction according to the first address step size, the up-sampling enable signal, the fill signal, the first base address, the first sequence group, and the first mask sequence.

14. The instruction generation method according to claim 7, wherein the matrix decoding signal includes a second hardware loop signal, a second address generation signal, and a matrix configuration signal; and the method further comprises:
generating a matrix configuration result according to the matrix configuration signal;
performing a second hardware loop process according to the second hardware loop signal, and obtaining a second sequence group and a second mask sequence;
performing a second address generation process according to the matrix configuration result, the second sequence group, the second mask sequence, and the second address generation signal, and obtaining the matrix computation instruction.

15. The instruction generation method according to claim 7, wherein the storage decoding signal includes a third hardware loop signal and a third address generation signal; and
the method further comprises:
performing a third hardware loop process according to the third hardware loop signal, obtaining a third sequence group and a third mask sequence;
performing a third address generation process according to the third address generation signal, the third sequence group, and the third mask sequence, and obtaining the storage medium.
